(19) United States
(12) Patent Application Publication
(10) Pub. No.: US 2025/0066581 A1
(43) Pub. Date: Feb. 27, 2025

(54) METHODS FOR MANUFACTURING METAL OXIDE INFUSED CONFORMAL COATING MATERIAL AND METAL OXIDE INFUSED CONFORMAL COATING MATERIAL MADE USING SAME

(71) Applicant: North Carolina State University, Raleigh, NC (US)

(72) Inventors: Robert Bruce Hayes, Clayton, NC (US); Samuel Charles Hanson, Durham, NC (US); Radek Michal Pudelko, Waxhaw, NC (US); Seamus Matthew McDonell, Melbourne, FL (US); Kerry Dale Frohling, Fullerton, CA (US); Joel Samuel Fechter, Huntington Beach, CA (US)

(21) Appl. No.: 18/814,002

(22) Filed: Aug. 23, 2024

Related U.S. Application Data
(60) Provisional application No. 63/534,706, filed on Aug. 25, 2023.

(51) Int. Cl. C08K 3/22; C09D 5/32; C09D 7/61; C09D 175/04

(52) U.S. Cl. CPC C08K 3/22; C09D 5/32; C09D 7/61; C09D 175/04; C08K 2003/221

(57) ABSTRACT

A method for manufacturing and applying a metal oxide coating for shielding an object from particle radiation includes heating a quantity of a resin of a polyurethane system and mixing a metal oxide with the quantity of the resin of the polyurethane system to form a mixture. The method further includes mixing a quantity of a hardener of the polyurethane system with the mixture to form a metal oxide infused conformal coating (MOICC). The method further includes applying the MOICC to an object to shield the object from particle radiation and curing the MOICC.

### PRIORITY CLAIM

This application claims the priority benefit of U.S. Provisional Patent Application Ser. No. 63/534,706, filed Aug. 25, 2023, the disclosure of which is incorporated herein by reference in its entirety.

### GOVERNMENT INTEREST

This invention was made with government support under grant number HQ0860-20-C7151 awarded by the Missile Defense Agency. The government has certain rights in the invention.

### TECHNICAL FIELD

The subject matter described herein relates to shielding for electronic devices. More particularly, the subject matter described herein relates to methods for manufacturing metal oxide infused conformal coating material and a metal oxide infused conformal coating material made using the methods.

### BACKGROUND

Electronic devices, such as semiconductor devices, are sensitive to ionizing radiation, such as nuclear particle radiation and photonic radiation. When electronic devices are deployed in environments with high concentrations of ionizing radiation, such as nuclear power generation facilities and spacecraft, it is desirable to shield the electronic components from the ionizing radiation. While using single element metallic shields, such as lead shields, is effective at blocking ionizing radiation, single element metallic shields are expensive in terms of mass penalty, potential toxicity and manufacturing cost.

Accordingly, there exists a need for improved methods for providing ionizing radiation shielding for electronic devices that avoids some of these difficulties.

### SUMMARY

A method for manufacturing and applying a metal oxide coating for shielding an object from particle radiation includes heating a quantity of a resin of a polyurethane system and mixing a metal oxide with the quantity of the resin of the polyurethane system to form a mixture. The method further includes mixing a quantity of a hardener of the polyurethane system with the mixture to form a metal oxide infused conformal coating (MOICC). The method further includes applying the MOICC to an object to shield the object from particle radiation. The method further includes curing the MOICC.

According to another aspect of the method, heating the quantity of the resin of the polyurethane system includes heating the quantity before mixing the metal oxide with the quantity of the resin.

According to another aspect of the method, heating the quantity of the resin of the polyurethane system includes heating the quantity of the resin to approximately 65° C.

According to another aspect of the method, the method includes cooling the mixture before mixing the quantity of the hardener with the mixture.

According to another aspect of the method, mixing the quantity of the hardener of the polyurethane system with the mixture includes pouring the quantity of the hardener into the mixture.

According to another aspect of the method, the metal oxide includes a high Z metal oxide.

According to another aspect of the method, the metal oxide includes gadolinium oxide (Gd₂O₃).

According to another aspect of the method, the polyurethane system includes Arathane® 5750 A/B (LV) urethane conformal coating.

According to another aspect of the method, a mass ratio between the quantity of the hardener and the quantity of the resin is approximately 1:5.

According to another aspect of the method, the MOICC includes approximately 50% of the metal oxide by mass.

According to another aspect of the method, applying the MOICC to the object includes pouring, brushing, spraying, or spreading the MOICC onto at least one surface of the object.

According to another aspect of the method, the object includes a printed circuit board.

Another aspect of the subject matter described herein includes a conformal metal oxide coating for shielding objects from particle radiation manufactured according to the heating and mixing steps of the method for manufacturing and applying the conformal metal oxide coating.

A conformal metal oxide coating product for shielding objects from particle radiation includes a metal oxide and a polyurethane system comprising a quantity of a resin and a quantity of a hardener. The conformal metal oxide coating product further includes instructions for heating the quantity of the resin, mixing the quantity of the resin with the metal oxide to create a mixture, and mixing the quantity of the hardener with the mixture.

According to another aspect of the conformal metal oxide coating, the metal oxide includes a high Z metal oxide.

According to another aspect of the conformal metal oxide coating, the metal oxide comprises gadolinium oxide (Gd₂O₃).

According to another aspect of the conformal metal oxide coating, the polyurethane system comprises Arathane® 5750 A/B (LV) urethane conformal coating.

### BRIEF DESCRIPTION OF THE DRAWINGS

The subject matter described herein will now be explained with reference to the accompanying drawings of which:

FIG. 1 is an image of a setup for an experiment for measuring the effectiveness of gamma radiation shielding. The gamma radiation source is directly under the shields in a way that no direct line of sight pathway reaches the HPGe crystal at the bottom of the detector;

FIG. 2 is a graph illustrating ₁₅₄Eu source detected through five stacked shields by Ortec Micro Detective HPGe with background subtracted and select photo peaks labeled;

FIG. 3 is a graph illustrating a NASA report that observes ELDRS effects in a reference voltage device;¹²

FIG. 4 is a graph illustrating a NASA report showing the effectiveness of radiation shielding as function of aluminum thickness;¹³

FIG. 5 is a graph plotting in candlestick style thicknesses of four PUR samples compared to four PMA samples;

FIG. 6 is a graph of energy peak ratios of MOICC with Gd over PUR without metal oxide infused. The dotted lines only represent linear interpolation between points;

FIG. 7 is a graph of energy peak ratios of MOICC with Gd over PUR without metal oxide infused;

FIG. 8 is a graph of energy peak ratios of MOICC with Gd over PUR without metal oxide infused in which masses are equal between the ratioed substances; and

FIG. 9 is a flow chart illustrating and example method for preparing a metal oxide coating for shielding an object from particle radiation.

### DETAILED DESCRIPTION

The following acronyms are used to describe metal oxide conformal coatings and methods for making and using the coatings.

### Acronyms

Z=Atomic (Proton) Number
TID=Total Ionizing Dose
RHA=Radiation Hardness Assurance
HDR=High Dose Rate
ELDRS=Enhanced Low Dose Rate Sensitivity
RadHard=Radiation Hardened (Device)
MOICC=Metal Oxide Infused Conformal Coating
PMA=Poly Methyl Acrylate
PUR=Polyurethane
MCNP=Monte Carlo N-Particle (Transport Code)
NASA=National Aeronautics and Space Administration
LEO=Low Earth Orbit

### Introduction

A novel bulk radiation shielding material is under development in order to meet the challenges that equipment must face in high radiation environments, such as that of outer space, new small modular nuclear reactors, and laboratory hot cells. In the American Nuclear Society's establishment of the Nuclear Grand Challenges, they discern the need for continued and accelerated development of advanced materials in the nuclear energy industry and in many other industries across the economy. They express the notable concern that “material issues lie at the heart of many of the technology issues that need to be solved.”¹ This report is dedicated to providing material features, gamma shielding characteristics, and potential outer space applications of the novel material under development.

This material, MOICC (metal oxide infused conformal coating) serves to capitalize on the properties of conformal coating. Conformal coating is a thin film usually sprayed or painted onto electronic components and is used to mechanically stabilize and insulate the internal components as well as reduce environmental stresses and protect against corrosion. The mixing and ultimate infusing of metal oxide powders within the coating improves the overall radiation hardness of the electronics that the material is covering. This may ultimately prove to be a cost-effective alternative or addition to traditional shielding techniques. Metal oxide powders have been selected for this application because of the shielding efficiency of the high Z metal. Furthermore, the oxidized chemical form makes the powder much more electrically and reactively inert, as a ceramic material.² The shielding type will serve multiple functions. While remaining a hermetic seal and protective conformal coating on the electronics, the metal oxide powder will attenuate more photons before reaching the internal electronics. The hydrogenous conformal coating shields against neutrons. With regards to other radiation types such as betas, protons, alphas and heavier ions, this material is not expected to be a substantial shielding improvement over existing technologies, however it may improve other aspects such as reduced costs, reduced overall mass, or reduced dose to electronics.

### MOICC Gamma Shielding Verification

This paper presents verification of gamma shielding effectiveness. Previous MCNP (Monte Carlo N Particle) modeling of an acrylic conformal coating³ determined that infusing layers of metal oxides into the coating significantly shielded photons from 10 to 300 keV. A factor of 300 reduction in photon flux below 10 keV was also observed. Less and less shielding effectiveness was observed as photon energy increased, particularly beyond 300 keV. The models suggested substantial shielding improvements with only slight weight increases.

These MCNP models were previously targeted for experimental validation with actual metal oxide infused PMA (poly methyl acrylate) acrylic conformal coating, the same coating type used in the simulations. However, even after numerous improved iterations, the acrylic conformal coating couldn't provide the desired properties necessary for a statistically distinguishable result. Furthermore, the acrylic coating samples showed concerning features that would challenge design implementation. While photon shielding testing with the PMA did provide expected general trends of improved photon shielding with incorporated metal oxides versus pure coating, a large uncertainty stemmed from the variation in material thickness. This variation, as well as other undesirable properties such as metal oxide particles precipitating out of the coating, seemed to have originated from the design of the PMA coating itself. Acrylic coatings are designed with substantial amounts of volatiles inside of the coatings. A previously tested acrylic coating had volatiles that accounted for over 70% of its mass during storage. After exposure to air, these volatiles may evaporate and provide a dried final product. This percentage is high in order to create a long shelf life for the coating, making it convenient to repeatedly open and close, and store for years between uses.

After this pursuit, it was determined that any coating used for this application should have minimal volatiles. The new primary contender became a coating that features two separate parts, so that the curing is caused by their mixing, and the coating doesn't rely on evaporation to cure. The most resilient of these chemical curing coatings was determined to be PUR (polyurethane). Resilience was reasoned to be based on a large elongation percentage, small coefficient of thermal expansion, minimal volatiles, and its previous successful applications as a conformal coating. This shielding experiment is thus incorporating a new PUR conformal coating combined with a previously selected metal oxide powder.

Of the metal oxide powders previously analyzed, the leading contender of gadolinium oxide, Gd₂O₃, was selected over the others for multiple reasons. For applications of shielding against artificial sources such as in laboratory hot cell, high neutron interaction cross sections are most desirable. These were the highest for gadolinium versus the other metals considered. Previous work determined that for gadolinium oxide's price, it had an exceptionally small D50 grain size of 2-10 μm with no particle observed larger than 20 μm. While this diameter distribution was identical to another metal oxide powder, erbium oxide, the gadolinium oxide is half as expensive.⁴ Other contenders of cerium oxide and tungsten oxide featured larger particle sizes for comparable prices. Furthermore, gadolinium oxide features two Gd atoms as compared to WO₃, tungsten oxide may have a higher Z metal, but a smaller molecular weight. Attempts at infusion in PUR led to the conclusion that finer metal oxide powders allow for more homogeneous infusion into the coating and thus makes finer powders more desirable. It is feasible that other heavy metal oxides will still fit this application, and other contenders may be considered in the future.

### Experimental Setup

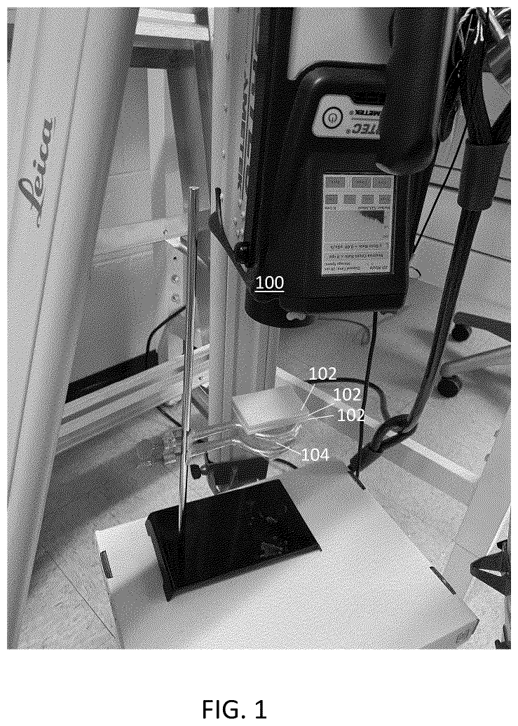

FIG. 1 illustrates an experimental setup used to evaluate the radiation shielding effectiveness of a metal oxide infused conformal coating. In this experiment, an Ortec Micro-Detective HPGe detector 100 serves as the target, and a plurality of shields 102 coated with the metal oxide infused conformal coating are placed between detector 100 and an ₁₅₄Eu source 104. Each shield 102 represents an MOICC with approximately 40 grams of total mass and 50 wt % gadolinium oxide. Each shield 102 is approximately 5-6 mm thick for context. These thicknesses are more closely examined later. After a long background spectrum is taken, source 104 is placed underneath shields 102 and a pure source spectrum is taken. Following this, a single shield 102 is placed between source 104 and target detector 100. After another spectrum, this is repeated with subsequent shields stacked on top of the previous. FIG. 1 shows a spectrum being collected with three shields 102 stacked, approximately 120 g of total material and an approximate thickness of 18 mm. The final spectrum taken is with 5 stacked shields. This process is repeated with PUR samples that feature no metal oxide (MO) for comparison.

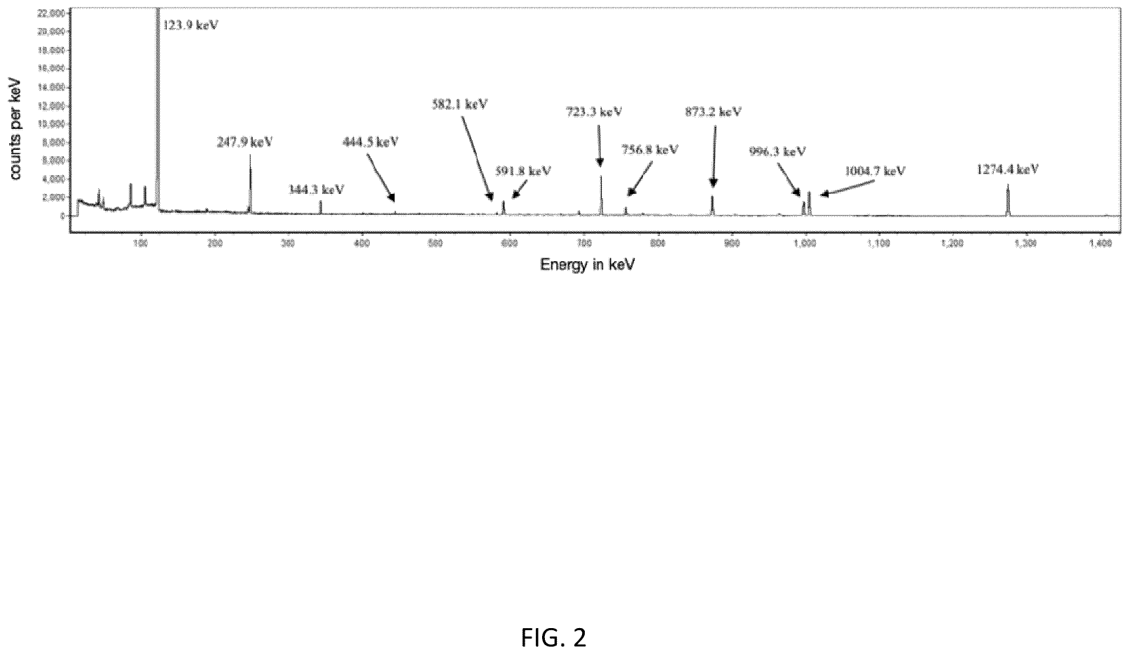

Spectra generated from the HPGe detector were then downloaded into Cambio. This software, provided by Sandia National Laboratory, fits Gaussian distributions from energy peaks.⁵ The europium source allows for analysis of several photon energy peaks from 0.123 MeV to 1.274 MeV. Shielding effectiveness estimates are particularly focused on the peaks at 123.1 and 247.9 keV, in order to verify previously drawn conclusions of the shielding effectiveness. These peaks are exemplified in FIG. 2. In Cambio, smaller peaks and peaks closer to others are generally integrated with larger variance. It is best practice to fit a peak by allowing the software as much spectral range as possible without incorporating a larger peak, this minimizes Gaussian fitting error.

### MOICC Potential Shielding Applications

In space, there is overall nuance regarding the best application for when this technology will best be applied in bulk. This nuance is based on the ultimate goals of any spacecraft. Most spacecraft lifespans are designed based on when they are expected to reach fuel exhaustion. In the case of shorter-lived spacecraft, some expenses and time could be saved if RadHard (radiation hardened) parts can be replaced by less RadHard parts and/or COTS (Commercial off-the-shelf) parts. Many RadHard electronics are produced in tiers based off of their TID (Total Ionizing Dose) levels; tiers that also increase in cost. They usually take ten years to develop following their non-RadHard equivalent. For longer lived satellites, usually at higher orbits where less fuel is required to maintain position, extra shielding may also allow for the replacement of RadHard parts with less RadHard parts. Extra shielding may eventually prove to be a standard for satellite electronics. This is because historical and modern shielding effort limits are compared against payload weight, which directly defines cost to launch. This will play less of a role in satellite manufacturing as the commercial space ventures continue to reduce the cost of launch. NASA estimated in 2018 that “in the most recent decade, commercial rocket development has reduced the typical space launch cost by a factor of 20, while NASA's launch cost to ISS has declined by a factor of 4.”⁶ They further expect that “reduced launch cost will directly allow heavier, more robust and reliable, and better performing spacecraft to be developed at lower cost.”

The potentially immediate applications are as follows. A thin layer replacement of the already present conformal coating on satellite electronics with MOICC will allow for a slight reduction in the required aluminum outer shell thickness, thus reducing payload mass. Some aluminum can be replaced with layers of high Z materials, as observed in previous research.⁷ These models provide an overall improvement of shielding against trapped magnetosphere particles and provide an overall decrease in payload mass. MOICC may not entirely replace the aluminum shell without proper analysis that the service of the aluminum shell as an electrical shield, or Faraday Cage, will still be performed. The electrical considerations needed to replace the external aluminum in its entirety are beyond the scope of this document. There is also good potential that if a thicker layer is allowed, then less RadHard parts may be ordered. This will reduce procurement costs and may also allow for slight Al hull thickness reduction, that would open up the possibility of cost reduction. Also, procuring RadHard parts requires long lead times due to the significant amount of time it takes to receive these parts after ordering them. Applying the MOICC onto non-RadHard parts instead of ordering RadHard parts allows for shorter lead times for space missions. However, for any contemporary satellite application, these should be considered on case by case bases. Over the long term, as declining launch costs decrease the barrier to space, MOICC has the potential to replace traditional conformal coating entirely, whether or not it replaces any aluminum on the spacecraft.

In other potential applications, laboratory operational hot cells require paint that is robust and can ideally shield against both photon and neutron irradiation. Curium, Americium, other combinational neutron/X ray sources that are worked with in these environments may be very effectively shielded against by this technology. Small modular nuclear reactors currently under development will also need compact shielding with similar abilities. These reactors are designed to be some of the smallest and least costly in the history of energy production, some small enough to fit on the back of a semi-trailer. Therefore, their radiation shielding materials must also maximize space and cost efficiency without sacrificing any other objectives of their designs. The compactness and dual shielding abilities of MOICC may complement these technologies well.

### MOICC Manufacturing Procedure

The current optimized manufacturing procedure is in Table I, and its origins are also described. This procedure targets a specific PUR for MOICC, in which part B is the resin and part A is the hardener. In the case of utilizing other brands of PUR, the only necessary adjustments are correlating which component is the resin and which component is the hardener to this procedure and making sure that heating of the resin will not provide adverse side effects. This should be determinable from the material data sheets. While multiple samples can be made from the same container, extra stirring should be performed between pours. If extra scraping needs to be performed to deposit the final sample, there is an increased likelihood of heterogeneity in that sample. The cured MOICC will strongly adhere to surfaces that it is allowed to cure on. If mold barriers are needed, silicone surfaces are the easiest to remove from the MOICC.

TABLE I
Preparation Procedure for PUR MOICC.

| Step # | Directions and Details | |
|---|---|---|
| I. | Keep mass of part A at 20% the mass of part B. | |
| II. | Care should be taken to account for losses and inaccuracies during the | |
| | process. Tracking the mass of each part, the metal oxide, and the | |
| | composite mixture at each stage along with the masses of the | |
| | container and stirrer is best practice. This allows for recalculation of | |
| | masses to account for errors and ensures the correct ratio of part A to | |
| | part B. | |
| III. | Recommended: Utilize a spreadsheet to actively track masses while | |
| | preparing. This allows one to automatically adjust portions of MO and | |
| | part A required following the initial pour of part B. | |
| 1. | Pour out part B. The most precise means is with a syringe. Deposit | |
| | Part B into container on scale. | |
| | a. | Recommended: Put container with Part B onto a hot plate and |
| | | heat to internal temperature of up to approximately 65° C. This |
| | | helps lower viscosity and expedite mixture of metal oxide |
| | | powder into part B. While 65° C. is the maximum temperature, it |
| | | isn't required. Any heating from room temperature will improve |
| | | mixing conditions. |
| 2. | Separately weigh desired mass of metal oxide powder. Our current | |
| | designs and procedures are targeting equal masses between MO and | |
| | PUR. Therefore, in weight %: MO = part B + part A. | |
| 3. | Remove container with Part B from hot plate. While Part B is cooling | |
| | to room temperature (about 25° C.), mix in the metal oxide powder to | |
| | part B resin. Roughly stir until it appears to be a homogeneous mixture | |
| | (approximately 1-2 minutes while heated, longer at room temperature). | |
| | Be sure to avoid material collection on sides of mixing container. | |
| 4. | Weigh out appropriate portion of part A (20 parts part A to 100 parts | |
| | part B). | |
| | a. | Recommended: Use a syringe and deposit part A directly onto |
| | | the part B and MO on top of a scale. Utilize a spreadsheet to |
| | | automatically calculate the desired additional mass that part A |
| | | should provide. |

| | |
|---|---|
| 5. | Mix in part A hardener. Roughly stir the mixture until the mixture |
| | appears to be a homogeneous mixture (Approximately 1-2 minutes |
| | while heated, slightly longer at room temperature) The amber colored |
| | part A should no longer be distinguishable. Be sure to stir on sides of |
| | container to not allow any congealment there. |
| 6. | Slowly stir until no air bubbles are visible (approximately 30-60 |
| | seconds). One should be able to watch bubbles surface and pop in |
| | beginning of this step. |
| 7. | Pour appropriate amount needed of MOICC onto surface or object to |
| | be protected. |
| 8. | Let cure for 24-72 hours at room temperature (25° C.) and atmospheric |
| | pressure. As a general rule, longer cure times should be given to larger |
| | samples. |

This procedure took on several iterations before production of quality samples was achieved. For example, introducing the metal oxide powder following the mixing of both parts was attempted, as well as mixing metal oxide with part A hardener before combining the parts. Both methods led to more frequent heterogeneous results. Similarly, a metal oxide content of 50% was determined after previous attempts at 50% and 55% metal oxide content led to increasing amounts of insoluble metal oxide powders left outside of the samples. External powder is a significant undesirable property for the potential applications, therefore later attempts introduced the hot plate for improved mixing. While in future research it will be possible to increase this percentage, some of the related materials science properties such as adhesion and tensile strength should be confirmed acceptable at this current percentage. Air bubbles were mitigated against in this procedure as well; a slow stirred finish successfully removes them as factors of concern. Concerns with changing the portions of hardener to resin in order to account for the introduction of MO proved inconsequential, as the latest product has ideal characteristics and keeps the portions the same as originally instructed by the manufacturer.

### MOICC Mass Compositions

Mass formulas are needed for radiation attenuation simulations and calculations. Our current models are determined for 50% metal oxide by mass, but factors are utilized here to allow for customization of metal oxide percentage. PUR is a class of polymers, created by the intermingling of various organic compounds, all attached by urethane links. Most PUR brand specific mass compositions are intellectual property, so the masses provided here are based on a generic PUR chemical formula, C₁₇H₁₆N₂O₄. These unknowns aren't major concerns for accurately modeling PUR however, because these mostly just disrupt the accounting accuracy of carbon, oxygen, and nitrogen. For radiation attenuation purposes, these elements are very similar to each other. Table II provides examples of attenuation coefficients at gamma ray energies of concern for the associated shielding experiment. The unknown exact amount of Hydrogen inside PUR is the greatest contribution to uncertainty in attenuation from mass calculations, particularly with neutrons as the radiative particle. It is for this reason that if any composition specifics can be provided by the manufacturer, it would ideally be mass fraction of H.

TABLE II
Gamma ray mass interaction coefficients across several energies of
concern for the elements C, N and O in units of cm²g⁻¹ . ⁸
Element and mass interaction coefficient:

| Energy | $\frac{μ}{ρ} ( \frac{{cm}^{2}}{g} )$ | | |
|---|---|---|---|
| (MeV) | Carbon | Nitrogen | Oxygen |
| 0.05 | 0.1734 | 0.1806 | 0.1916 |
| 0.1 | 0.1476 | 0.1482 | 0.1492 |
| 0.15 | 0.133 | 0.1331 | 0.1334 |
| 0.2 | 0.1220 | 0.1220 | 0.1221 |

With gadolinium oxide powder as the frontrunner for the application, its individual mass composition is provided, then it requires multiplying by an infusion factor for the intended amount of metal oxide powder within the MOICC.

Our infusion factor, for example, will be 0.5 because we intend to have 50% of mass metal oxide. Table III below provides details for this. The selected generic PUR chemical formula is also provided for this, a switch in the number of H, C, N, and O atoms that can make the conversion to other PUR and polymers a minor task. Since oxygen appears in both the MO and PUR, it is more convenient to separate them for calculations and then combine their weight percents as a last step. Note that this chemistry problem can be solved in multiple ways.

TABLE III
Atomic and Mass specifics for pertinent elemental mass
compositions, using Gd₂O₃ and C₁₇H₁₆N₂O₄

| | | | | | Infusion | |
|---|---|---|---|---|---|---|
| | | # of | At | Wt | Factor | MIOCC |
| Element | AMU | Atom | % | % | (50%) | Wt % |
| Gd | 157.253 | 2 | 40 | 86.76 | 0.5 | 43.38 |
| O (MO) | 16 | 3 | 60 | 13.24 | 0.5 | 6.62 |
| H | 1 | 16 | 41.03 | 5.13 | 0.5 | 2.56 |
| C | 12 | 17 | 43.59 | 65.38 | 0.5 | 32.69 |
| N | 14 | 2 | 5.13 | 8.97 | 0.5 | 4.49 |
| O (PUR) | 16 | 4 | 10.26 | 20.51 | 0.5 | 10.26 |

### Novel Composite Material Property Specifics

Before this material can be approved for applications, multiple materials science prerequisites must be met. While this is a new composite material, its adhesive binding, polyurethane coating, has already been approved for the most extreme environment of space. Therefore, instead of determining all of the material properties from scratch, one can assume from a starting position of an already approved material, and isolate the potential qualities that may drift away from the original coating. This assumption is based on the general rule of mixtures of composite materials. These properties primarily include material tensile strength, elongation percent, adhesiveness, thermal expansion, thermal conductivity, and electrical conductivity. The high Z metals were selected in the chemical form of metal oxide powders in part to minimize some of these concerns.

Following the rule of mixtures of composite materials, it is unlikely that major changes in the new material mass density, coefficient of thermal expansion, ultimate tensile strength, electrical conductivity, and thermal conductivity will be observed.⁹ Regarding potential changes to electrical conductivity, metal oxide powders are ceramics. Pure metals frequently have electrical conductivities on the range of 10² to 10⁸ [Ω-m]⁻¹, The other major material types, ceramics, polymers, as well as composites of the two (with which MOICC is categorized as) all feature similar conductivity ranges of 10⁻⁹ to 10⁻¹⁷ [Ω-m]⁻¹. So, a significant change to the material's electrical conductivity is extremely unlikely. Similarly, significantly different responses to thermal changes are also unlikely. The coefficient of thermal expansion within the metal oxide powder is much smaller than that of the already space-approved conformal coating. The combined material will thus most likely feature an overall reduced coefficient of thermal expansion. The general rule of mixtures is an ideal first approximation for determining material properties, and has been a reason why this design concept is so promising. However, with the novelty of the new material, and the relatively expensive intended applications as compared to the testing costs, testing to determine these property values is highly recommended.

### Dose in Space vs Radiation Hardness Assurance Testing

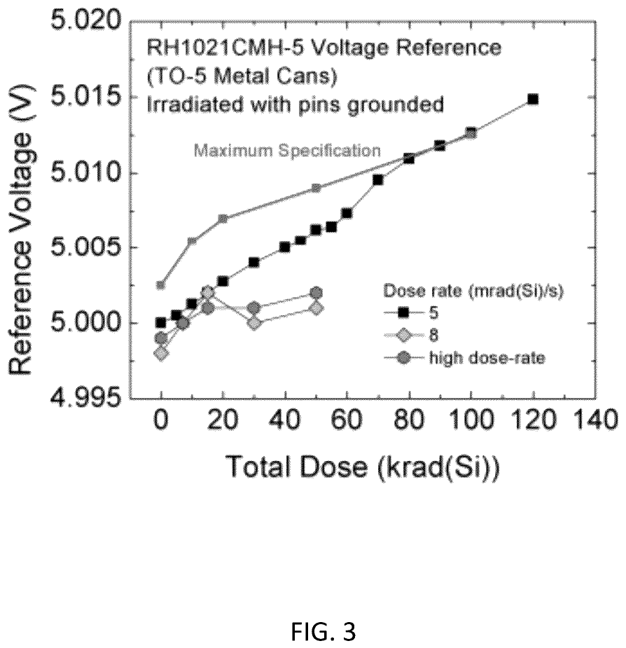

As space is a primary target for this application, it is important to characterize radiation in space, particularly in Low Earth Orbit, as well as characterize how it is determined to handle space conditions before launch. How this is addressed in modern testing standards is with TID (Total Ionizing Dose) RHA (Radiation Hardness Assurance) testing. The standard HDR (High Dose Rate) version of TID tests involve irradiation with a ⁶⁰Co source. This radionuclide's decay chain emits two high energy gamma rays at the energies of 1.17 and 1.33 MeV. This is the industry standard because of its highly efficient means of energy deposition into a device's silicon region combined with the relatively easy production of this radionuclide. This testing allows an electronic's semiconductors to acquire over 100 krad (Si) in less than a week.¹⁰ However, during attempted repeats of these highly efficient tests, some types of electronics such as bipolar circuits were seemingly handling higher dose rates more effectively. This culminated in the partitioning of TID testing into HDR and ELDRS (Enhanced Low Dose Rate Sensitivity) testing. While the name ELDRS is now well established, it is contemporarily a misnomer. Originally, it was suspected that dose damage was enhanced at lower rates; dose damage is now understood to be reduced at higher rates.¹¹ This can be exemplified in FIG. 3 reported by NASA in which they confirmed low dose rate effects led to the part drifting out of specifications quicker than when it is tested with the standard high dose rate.¹² This reference voltage device is designed to continuously output a constant voltage; drift in its voltage output is evident as it acquires further TID at varying rates.

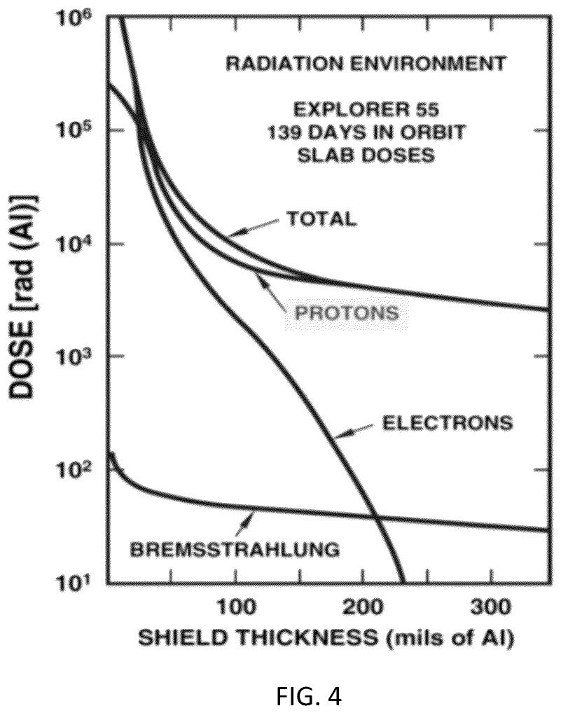

In outer space, satellite electronics are primarily dosed by trapped electrons and protons in the Earth's magnetosphere, as well as X rays. This is particularly true with LEO. Other sources include Galactic Cosmic Rays and Solar particles. In well shielded scenarios, the primary source of dose in electronics is from high energy protons around 30 MeV and above, as electrons are attenuated. FIG. 4 characterizes doses to Al as a part of their better understanding of Al as an external shield.¹³

Not only does particle dose rate have an effect on an electronic's response, but particle type and energy are also critical to effectively shielding it. MOICC shielding technology targets protons and electrons, heavy ions, and Bremsstrahlung (X rays) across various energies. It is expected that the higher energies of the tested ¹⁵⁴Eu source will not experience significant attenuation as compared to both pure PUR and the absence of material altogether. This means if MOICC is applied to a circuit board before standard TID testing is performed, it is expected to have minimal impact on the results. This lack of shielding performance doesn't correlate to how the MOICC will shield in its satellite application, where it is expected to reduce dose to the electronics.

### Results

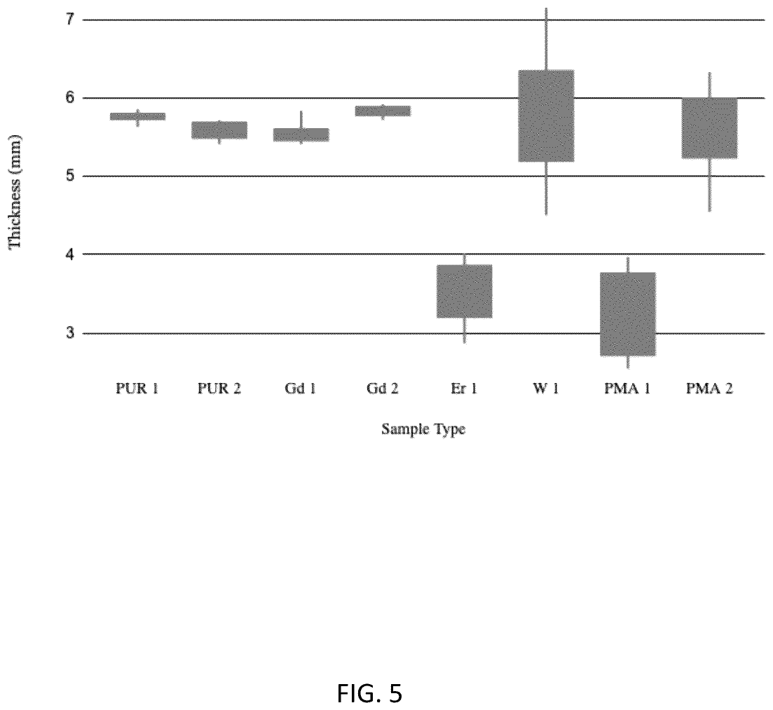

As previous PMA models expressed the notable concern of thickness variation between samples and across individual samples themselves, thickness measurements between four of the latest set of MOICC PUR samples and the last four MOICC PMA samples are compared in FIG. 5. The range covers lowest to highest measured values, while the boxes represent 1st to 3rd quartiles. In this figure, the first four candlestick plots that represent PUR feature thickness ranges and spreads that are substantially smaller than that of the four PMA samples. One can see the primary source of error in previous shielding estimates for PMA, thickness variation, has been effectively reduced for PUR shielding results.

Shielding results are exemplified in ratios. The energy peaks captured through MOICC shields are divided by the same energy peaks with just PUR shields. Thus 100% of energy peak intensity corresponds to a lack of effective photon shielding, and 0% means all photons at that energy peak have been shielded by the introduction of MOICC.

In previous PMA results, large shield thickness variations led to an average standard deviation of 14%±6%.¹⁴ As the largest source of error, thickness variation has been substantially reduced in these shields in comparison, therefore, error here is conservatively reported as a reduction by a factor of two. A follow up p-study experiment is expected to confirm this conservative value. The other major potential source of error, Cambio Gaussian modeling software, is excluded as its variance is an order of magnitude less than that from thickness variation at the energy peaks of significance, and frequently for the smaller peaks at higher energies as well.

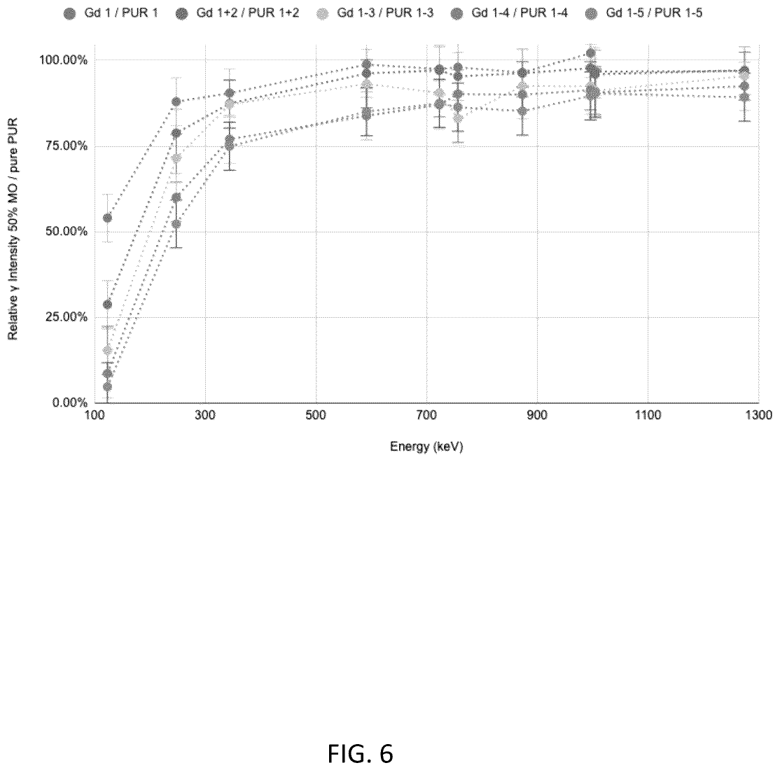

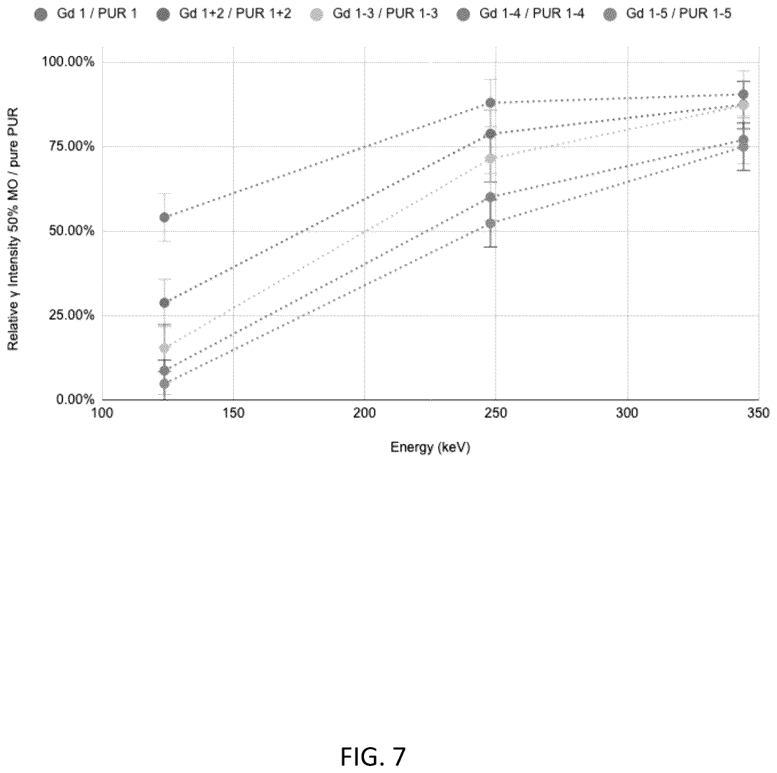

FIG. 6 shows all five Gd oxide infused conformal coat to PUR conformal coat ratios. The energies of interest at 123, 248 and 344 keV are further focused on in FIG. 7. The introduction of gadolinium oxide at 50 wt % in 20 g of PUR reduced energy peak intensity at 123 keV to 53.9% of that of PUR. With a similar replacement at 100 g of PUR, energy peak intensity is at 4.7% of that of PUR alone. Similarly, for 248 keV peak, energy peaks were reduced to 87.8% and 52.8% of intensity, respectively. At higher energies, the shielding worth appears insignificant as previous models and experiments observed.

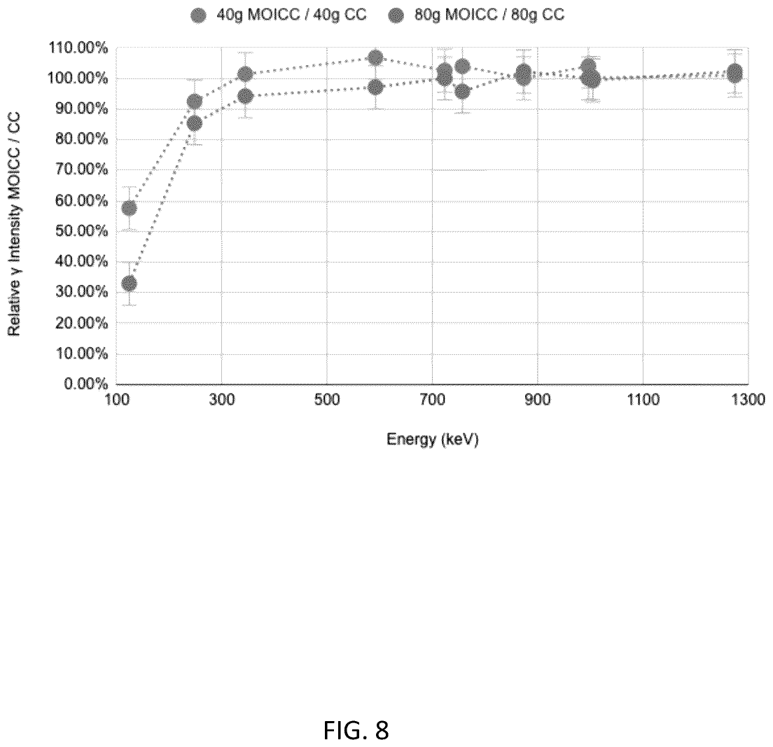

The results for comparable masses are shown in FIG. 8. In this equal mass analysis, 40 g of MOICC is shown performing against 40 g of PUR. The 123 keV energy peak is reduced to 57.6% of its counts during collection with PUR shielding. Similarly, the 248 keV energy peak is reduced to 92.4% of how it is attenuated passing through 40 g of PUR. Less and less shielding effectiveness for either sample is observed at higher energies, again as expected. This is evidence that any conformal coating will not improve an electronic's performance in a standard TID testing procedure with a ⁶⁰Co source. 80 g of MOICC is also compared against 80 g of PUR, as well. The 123 keV peak is reduced to 32.9% with the replacement of half of the PUR with MO. The 248 keV peak is reduced to 85.3%. Previous models emphasized the shielding effectiveness particularly at lower models, and this is also concluded in this experiment. The target photon radiation for this shielding technology is in the X Ray range, as well as lower energy gamma rays.

### Future Research

There are several pathways forward to aid this technology in its progression. This shielding analysis can be expanded on by utilizing MCNP and its p-study feature. As the thickness concerns are greatly reduced, an MCNP analysis is expected to produce a multi factor reduction in error as compared to similar results with PMA. Future research may also look into acquiring the specific interaction coefficient of this composite material. A series of material science properties, as mentioned earlier, such as adhesiveness, conductivities, and tensile strength are also recommended. Following these, future research may explore other metal oxide powders and conformal coatings besides the current leading contenders of gadolinium oxide and PUR. Increase in the metal oxide percentage may also be explored. Modeling against protons above 30 MeV, as well as lower energy protons and electrons will also further qualify this technology for shielding in LEO, particularly as it is compared with up to 300 mils of aluminum. Electrical analysis may be performed in the cases in which the entire aluminum hull would be replaced by MOICC shielding.

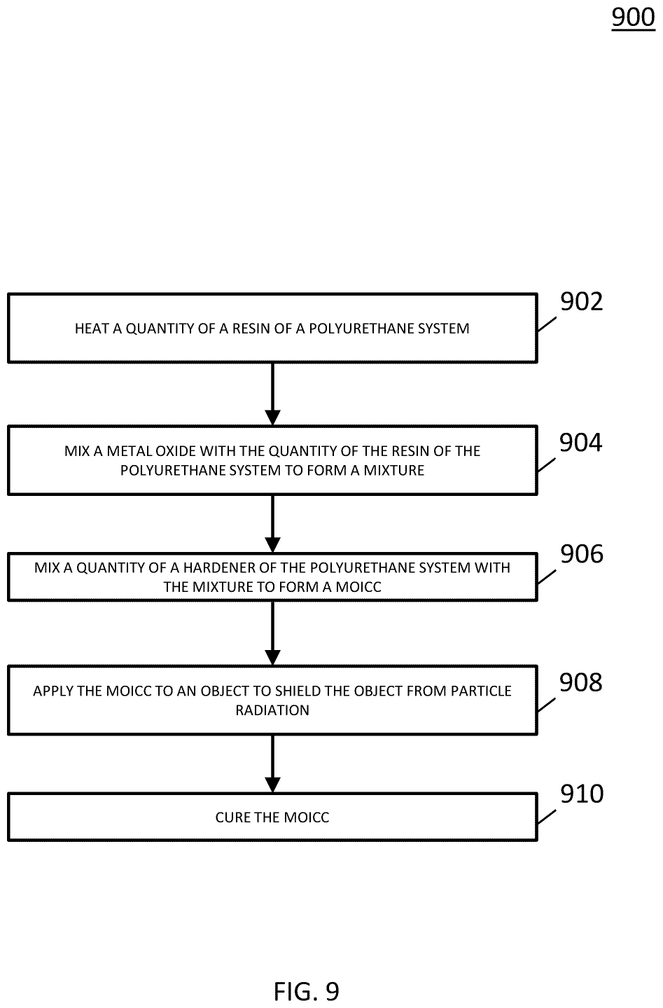

FIG. 9 is an example method 900 for manufacturing and applying a metal oxide coating for shielding an object from particle radiation. Particle radiation may include protons, neutrons, electrons, alpha particles, beta particles, and/or heavy ions. Referring to FIG. 9, at step 902, method 900 includes heating a quantity of a resin of a polyurethane system. The resin may include a resin blend. The polyurethane system may include a two-component urethane system, for example Arathane® 5750 A/B (LV) urethane conformal coating. The quantity of the resin of the polyurethane system may be heated before mixing the metal oxide into the quantity of the resin. The quantity of the resin may be heated to an internal temperature of approximately 65° C. Alternatively, the quantity of the resin may be heated to an internal temperature of lower than 65° C., for example below 45° C., 45° C., 50° C., 55° C., or 60° C., or to a higher internal temperature, for example 70° C., 75° C., or higher.

At step 904, method 900 includes mixing a metal oxide with the quantity of the resin of the polyurethane system to form a mixture. The metal oxide may include a high Z metal oxide, for example and without limitation, gadolinium oxide (Gd₂O₃).

At step 906, method 900 further includes mixing a quantity of a hardener of the polyurethane system with the mixture to form a metal oxide infused conformal coating (MOICC). The hardener may include diisocyanate. The mixture may be cooled before mixing the quantity of the hardener with the mixture. Mixing the quantity of the hardener of the polyurethane system with the mixture may include pouring the quantity of the hardener into the mixture. A mass ratio between the quantity of the hardener and the quantity of the resin may be approximately 1:5. The MOICC may include approximately 50% of the metal oxide by mass.

At step 908, method 900 further includes applying the MOICC to an object to shield the object from particle radiation. The MOICC is a pourable liquid, which provides many applications. For example, the MOICC may be used in three-dimensional (3D) printing or poured into a mold formed to cover electronics. Applying the MOICC to the object may include pouring, brushing, spraying, or spreading the MOICC onto at least one surface of the object. The object may include a printed circuit board.

At step 910, method 900 further includes curing the MOICC. Curing can include allowing the MOICC to harden on the surface or object being coded. The cure time can be 24-72 hours at room temperature (25° C.) and atmospheric pressure. As stated above, longer cure times can be used for larger samples.

The disclosure of each of the following references is incorporated herein by reference in its entirety.

### REFERENCES

1. American Nuclear Society: Nuclear Grand Challenges: Advanced Materials: https://www.ans.org/challenges/materials/ (current as of November 2021).
2. W. D. CALLISTER, & D. G. RETHWISCH, “Materials Science & Engineering, An Introduction,” Wiley & Sons Publishing Inc. Hoboken, NJ (Dec. 2009).
3. M. DEVANZO & R. B. HAYES, “Ionizing Radiation Shielding Properties of Metal Oxide Impregnated Conformal Coatings,” Radiation Physics and Chemistry, 171, 108685 (2020).
4. S. C. HANSON, R. M. PUDELKO, R. B. HAYES, “Preliminary Material Property Characterization of Metal Oxide Infused Conformal Coats for Shielding Applications,” American Nuclear Society Winter Meeting and Technology Expo, Washington, D.C (Nov. 30-Dec. 4, 2021).
5. W. JOHNSON, USDOE. Cambio. Computer software. https://www.osti.gov//servlets/purl/1232481. (2015).
6. H. W. JONES, “The Recent Large Reduction in Space Launch Cost,” NASA Ames Research Center, 48th International Conference on Environmental Systems, Albuquerque, NM, (July 2018) https://ttu-ir.tdl.org/bitstream/handle/2346/74082/ICES_2018_81.pdf
7. L. VARGA and E. HORVATH, “Evaluation of Electronics Shielding in Micro-satellites,” Defense R&D Canada—Ottawa, (Feb. 2003). https://cradpdf.drdcrddc.gc.ca/PDFS/unc06/p519025.pdf
8. R. E. FAW, J. K. SHULTIS, Radiological Assessment, Appendix D, American Nuclear Society, Inc. La Grange, IL (1999).
9. University of Cambridge: Department of Materials Science and Metallurgy: Derivation of the rule of mixtures inverse rule of mixtures, https://www.doitpoms.ac.uk/tlplib/bones/derivation_mixture_rules.php (current as of Nov. 2021).
10. R. BAUMANN, K. KRUCKMEYER “Radiation Handbook for Electronics,” Texas Instruments, Dallas, TX (2020).
11. R. L. PEASE, R. D. SCHRIMPF, & D. M. FLEETWOOD, “ELDRS in Bipolar Linear Circuits,” IEEE Transactions on Nuclear Science Vol. 56 (Aug. 2009). https://ieeexplore.ieee.org/document/5782678
12. J. CHEN, J. D. FORNEY, R. L. PEASE et. al. “The Effects of ELDRS at Ultra-Low Dose Rates,” NASA Electronics Parts and Packaging program, IEEE (Jul. 2010). https://ntrs.nasa.gov/api/citations/20110015280/downloads/20110015280.pdf
13. R. A. Cliff, V. Danchenko, E. G. Stassinopoulos, M. Sing, G. J. Brucker, and R. S. Ohanian, “Prediction and Measurement of Radiation Damage to CMOS Devices on Board Spacecraft,” NASA Goddard Space Flight Center IEEE Trans. Nucl. Sci. NS-23, 1781 (1976).
14. S. C. HANSON, R. M. PUDELKO, R. B. HAYES, “Gamma Shielding Assessment of Metal Oxide Infused Conformal Coating,” American Nuclear Society Winter Meeting and Technology Expo, Washington, D.C, (Nov. 30-Dec. 4, 2021).
15. Hanson SC. Polymer Composite Radiation Shielding with Computational Radiation Hardness Assurance Methods for Spacecraft Electronics. Doctoral Thesis, North Carolina State University [online]; 2024. Available at: https://www.lib.ncsu.edu/resolver/1840.20/42766

What is claimed is:

1. A method for manufacturing and applying a metal oxide coating for shielding an object from particle radiation, the method comprising:
heating a quantity of a resin of a polyurethane system;
mixing a metal oxide with the quantity of the resin of the polyurethane system to form a mixture;
mixing a quantity of a hardener of the polyurethane system with the mixture to form a metal oxide infused conformal coating (MOICC);
applying the MOICC to an object to shield the object from particle radiation; and
curing the MOICC.

2. The method of claim 1 wherein heating the quantity of the resin of the polyurethane system comprises heating the quantity before mixing the metal oxide with the quantity of the resin.

3. The method of claim 2 wherein heating the quantity of the resin of the polyurethane system comprises heating the quantity of the resin to approximately 65° C.

4. The method of claim 3 comprising cooling the mixture before mixing the quantity of the hardener with the mixture.

5. The method of claim 1 wherein the metal oxide comprises a powder and mixing the metal oxide into the quantity of resin includes stirring the powder into the quantity of resin.

6. The method of claim 1 wherein mixing the quantity of the hardener of the polyurethane system with the mixture comprises pouring the quantity of the hardener into the mixture.

7. The method of claim 1 wherein the metal oxide comprises a high Z metal oxide.

8. The method of claim 1 wherein the metal oxide comprises gadolinium oxide (Gd₂O₃).

9. The method of claim 1 wherein the polyurethane system comprises Arathane® 5750 A/B (LV) urethane conformal coating.

10. The method of claim 1 wherein a mass ratio between the quantity of the hardener and the quantity of the resin is approximately 1:5.

11. The method of claim 1 wherein the MOICC comprises approximately 50% of the metal oxide by mass.

12. The method of claim 1 wherein applying the MOICC to the object includes pouring, brushing, spraying, or spreading the MOICC onto at least one surface of the object.

13. The method of claim 1 wherein the object comprises a printed circuit board.

14. A conformal metal oxide coating for shielding objects from particle radiation manufactured according to the heating and mixing of claim 1.

15. A conformal metal oxide coating product for shielding object from particle radiation, the conformal coating product comprising:
a metal oxide;
a polyurethane system comprising a quantity of a resin and a quantity of a hardener; and
instructions for heating the quantity of the resin, mixing the quantity of the resin with the metal oxide to create a mixture, and mixing the quantity of the hardener with the mixture.

16. The conformal metal oxide coating product of claim 15 wherein the metal oxide comprises a high Z metal oxide.

17. The conformal metal oxide coating product of claim 15 wherein the metal oxide comprises gadolinium oxide (Gd₂O₃).

18. The conformal metal oxide coating product of claim 15 wherein the metal oxide comprises a powder.

19. The conformal metal oxide coating product of claim 15 wherein the instructions for heating the quantity of resin include an instruction for heating the quantity of resin to a temperature of 65° C.

20. The conformal metal oxide coating product of claim 15 wherein the polyurethane system comprises Arathane® 5750 A/B (LV) urethane conformal coating.
